(19) United States
(12) Patent Application Publication
(10) Pub. No.: US 2008/0316878 A1
(43) Pub. Date: Dec. 25, 2008

(54) METHOD FOR MEASURING THICKNESS AND MEASURING DEVICE USING THE SAME

(75) Inventor: Fung-Hsu Wu, Taoyuan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: DAXON TECHNOLOGY INC., Taoyuan County (TW)

(21) Appl. No.: 11/926,159

(22) Filed: Oct. 29, 2007

(30) Foreign Application Priority Data
Jun. 22, 2007 (TW) 96122581

(51) Int. Cl. G11B 7/00

(52) U.S. Cl. 369/44.23

(57) ABSTRACT

A method for measuring thickness of a transparent layer and a measuring device using the same are provided. The transparent layer has a first face, a second face and a normal direction. The method includes the following steps. First, a light beam with a focal point is emitted to the transparent layer. Next, a focus error signal (FES) is generated according to a refracted beam of the light beam. Then, the focal point is moved along the normal direction and passes through the first face and the second face. The FES converts into a first focus error curve and a second focus error curve respectively when the focal point passes through the first and the second face. Afterwards, the thickness of the transparent layer is obtained according to the first focus error curve and the second focus error curve.

This application claims the benefit of Taiwan application Serial No. 96122581, filed Jun. 22, 2007, the subject matter of which is incorporated herein by reference.

### BACKGROUND OF THE INVENTION

1. Field of the Invention

The invention relates in general to a method for measuring thickness and a measuring device using the same, and more particularly to a method for measuring thickness of a transparent layer and a measuring device using the same.

2. Description of the Related Art

The method for measuring the thickness of the material layer in an optical disc is usually executed by a white light spectrometer. Referring to FIG. 1, a diagram showing spectrom inspection result and thickness change of material layer is illustrated. The curve C1 denotes the change in the thickness of the material layer. The curve C2 denotes the change in the thickness of the material layer measured by using the white light spectrom. The diameter D of the focal point of the light beam L emitted by the white light source in the white light spectrum is normally around 500 μm. Compared with the tiny thickness differences in the surface of the material layer, a relative large diameter D is more likely to result in error measurement and insufficient number of detecting points per measuring unit, and therefore the resolution of sampling would be deteriorated greatly. Thus, while analyzing thickness with the white light spectrometer, the change in the thickness of the material layer can not be measured precisely, resulting in inconsistency between the curve C2 and the curve C1 and making the estimation of the quality of the optical disc unreliable.

Currently, another method for measuring thickness by way of a laser interferometer is available. A laser beam is emitted to the optical disc and passing through the material layer, the interference fringe of the laser beam reflected by the material layer is received by a sensor. Then, the fringe period is calculated via a fast Fourier transform (FFT) calculation, and the thickness is obtained accordingly. However, when the above method is used for measuring the thicknesses of multi-material layers, for example, for measuring the thicknesses of the material layers of a single-side-double-layered DVD optical disc, a more complicated interference fringe will be resulted. Furthermore, the peak value obtained from the FFT will be extended and shifted because of the dispersion of each material. As a result, the thicknesses calculated from above method need correct.

### SUMMARY OF THE INVENTION

The invention is directed to a method for measuring thickness and a measuring device using the same. The thicknesses of different transparent layers are obtained according to a focus error signal (FES) of a refracted beam. The thicknesses of the material layers are obtained instantly and correctly in this invention. Since no additional element is required, the measuring method and the measuring device using the same are compatible with the optical disc driving system.

According to one aspect of the present invention, a method for measuring thickness of a transparent layer is provided. The transparent layer has a first face, a second face and a normal direction. First, a light beam with a focal point is emitted to the transparent layer. Next, a focus error signal (FES) is generated according to a refracted beam of the light beam. Then, the focal point is moved along the normal direction and passes through the first face and the second face. The FES converts into a first focus error curve and a second focus error curve respectively when the focal point passes through the first face and the second face. Afterwards, the thickness of the transparent layer is obtained according to the first focus error curve and the second focus error curve.

According to another aspect of the present invention, a method for measuring thicknesses of multiple transparent layers of an optical storage medium is provided. The optical storage medium has a first face, a second face, a third face and a normal direction. First, a light beam with a focal point is emitted to the medium. Next, an FES is generated according to a refracted beam of the light beam. Then, the focal point is moved along the normal direction and passes through the first face, the second face and the third face. The FES converts into a first focus error curve, a second focus error curve and a third focus error curve respectively when the focal point passes through the first face, the second face and the third face. Afterwards, the thicknesses of the transparent layers are obtained according to the first focus error curve, the second focus error curve and the third focus error curve.

According to a further aspect of the present invention, a measuring device for measuring thickness of a transparent layer is provided. The transparent layer has a first face, a second face and a normal direction. The measuring device includes a light emitting element, a sensing element and a processing element. The light emitting element is used for emitting a light beam to the transparent layer. The sensing element is used for sensing a refracted beam of the light beam, and an FES is generated according to the refracted beam. The processing element is connected to the sensing element. The FES converts into a first focus error curve and a second focus error curve respectively when a focal point of the light beam moves along the normal direction and passes through the first face and the second face. The processing element obtains the thickness of the transparent layer according to the first focus error curve and the second focus error curve.

The invention will become apparent from the following detailed description of the preferred but non-limiting embodiments. The following description is made with reference to the accompanying drawings.

### BRIEF DESCRIPTION OF THE DRAWINGS

FIG. 1 is a diagram showing spectrom inspection result and thickness change of material layer;

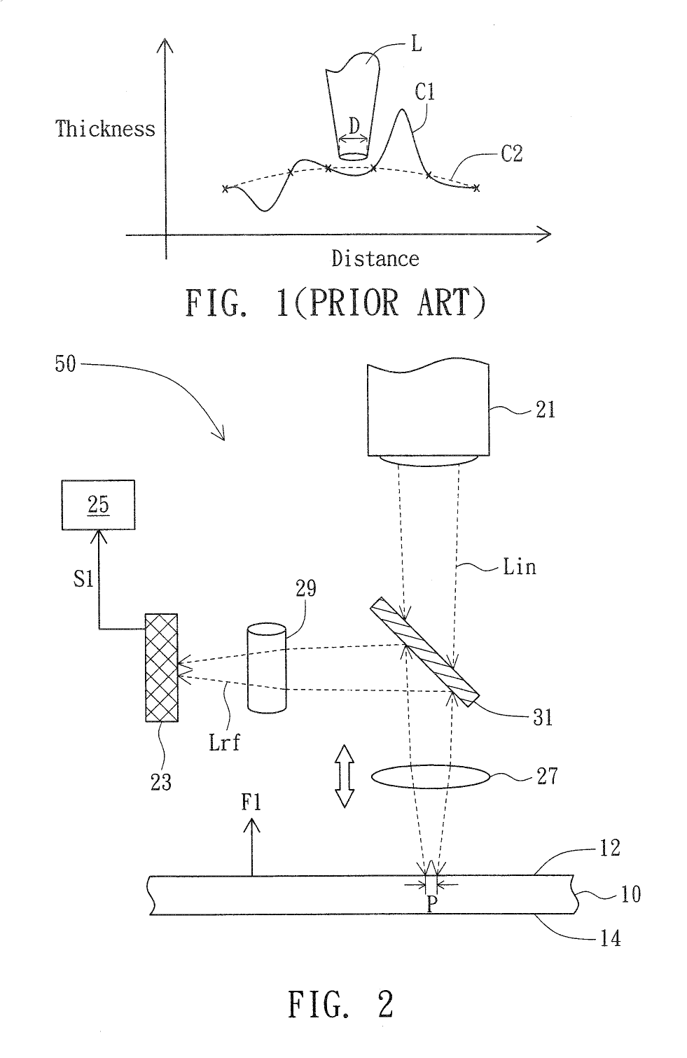

FIG. 2 is a perspective of a measuring device according to a first embodiment of the invention and a transparent layer;

FIGS. 3A˜3C are diagrams illustrating the movement of the focal point passing through a first face;

FIG. 4 is a diagram showing the intensity of focal error signal; and

FIGS. 5A˜5G are diagrams illustrating the movement of the focal point passing through the first face, the second face and the third face of an optical storage medium.

### DETAILED DESCRIPTION OF THE INVENTION

Two embodiments are disclosed below for elaborating the details of the invention, but these embodiemtns are not for limiting the scope of protection of the invention. Besides, unnecessary elements are omitted in the drawings of the following embodiments to clearly highlight the technical features of the invention.

### First Embodiment

The method for measuring thickness disclosed in the present embodiment of the invention is exemplified by the thickness mearurement of a transparent layer. First, a light beam with a focal point is emitted to the transparent layer. Next, a focus error signal (FES) is generated according to a refracted beam of the light beam. Then, the focal point is moved along a normal direction of the transparent layer and passes through a first face and a second face of the transparent layer. The FES converts into a first focus error curve and a second focus error curve respectively when the focal point passes through the first face and the second face. In the method for measuring thickness of the present embodiment of the invention, the thickness of the transparent layer is obtained according to the first and the second focus error curve.

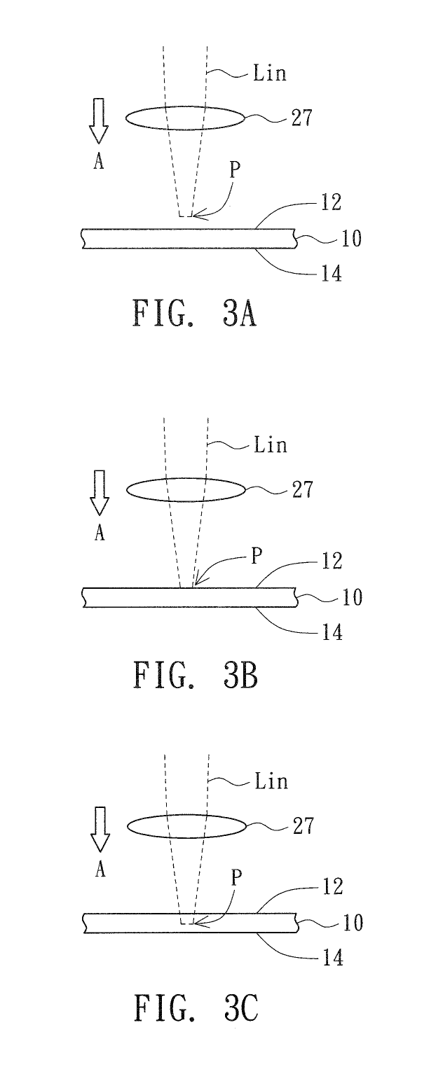

The method for measuring thickness of the present embodiment of the invention is executed by a thickness measuring device. Referring to FIG. 2, a perspective of a measuring device according to a first embodiment of the invention and a transparent layer is shown. The measuring device 50 is used for measuring the thickness of the transparent layer 10 that has a first face 12, a second face 14 and a normal direction F1. The measuring device 50 includes a light emitting element 21, a sensing element 23 and a processing element 25. The light emitting element 21 is used for emitting a light beam Lᵢₙ to the transparent layer 10. The sensing element 23 is used for sensing a refracted beam L_{rf} of the light beam Lᵢₙ, and generatign a FES S1 according to the refracted beam L_{rf}. The processing element 25 is connected to the sensing element 23. The FES S1 converts into a first focus error curve and a second focus error curve respectively when the focal point P of the light beam Lᵢₙ moves along the normal direction F1 and passes through the first face 12 and the second face 14. The processing element 25 obtains the thickness of the transparent layer 10 according to the first focus error curve and the second focus error curve.

The measuring device 50 further includes a focusing element 27, a beam splitter 31 and an astigmatic lens 29. The focusing element 27 and the beam splitter 31 are disposed between the light emitting element 21 and the transparent layer 10. The light beam Lᵢₙ emitted by the light emitting element 21 preferably passes through the beam splitter 31 and the focusing element 27 sequentially, and then the light beam Lᵢₙ is focused by the focusing element 27 to form a focal point P. In the present embodiment of the invention, the focal point P is moved by way of moving the focusing element 27 along the normal direction F1. The light beam Lᵢₙ is partly reflected when emitted to the transparent layer 10. The reflected light beam is refracted to the astigmatic lens 29 by the beam splitter 31, and then the light is refracted by the astigmatic lens 29 to form the refracted beam L_{rf}. Then, the refracted beam L_{rf} is projected on the sensing element 23. Normally, the astigmatic lens 29 is a cylindrical lens. When the focal point P is located at different positions on the transparent layer 10, the refracted beam L_{rf} passing through the astigmatic lens 29 is focused as different focusing states accordingly. The sensing element 23 preferably is a four-quadrant optoelectronic detector which outputs the FES S1 according to the distribution of the light spots projected on the detector by the refracted beam L_{rf}. Any one who is skilled in the technology of the invention will undersand the theory and function of the four-quadrant optoelectronic detector as well as the generation of the FES S1, and the details thereof are not repeated here.

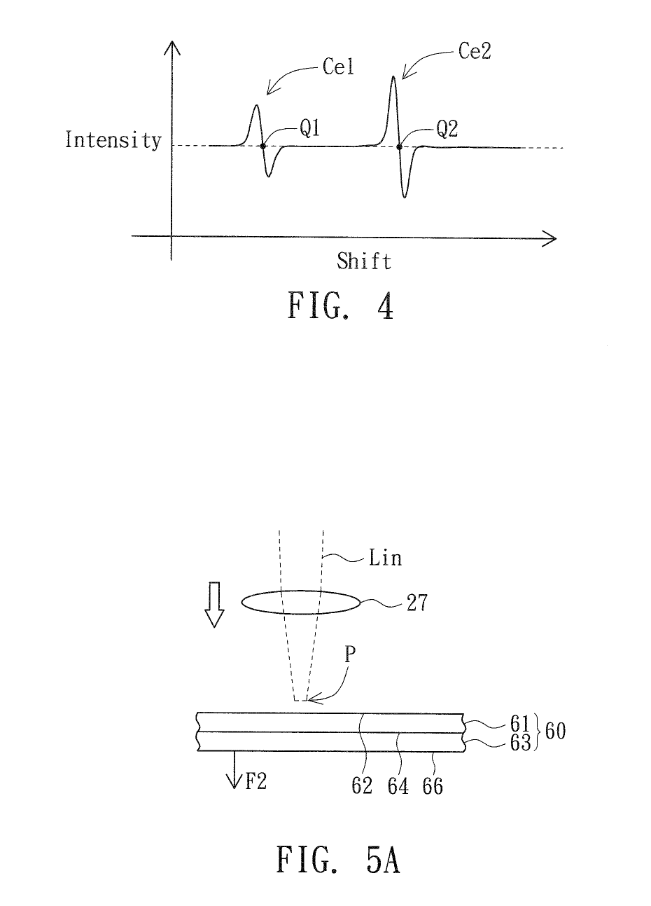

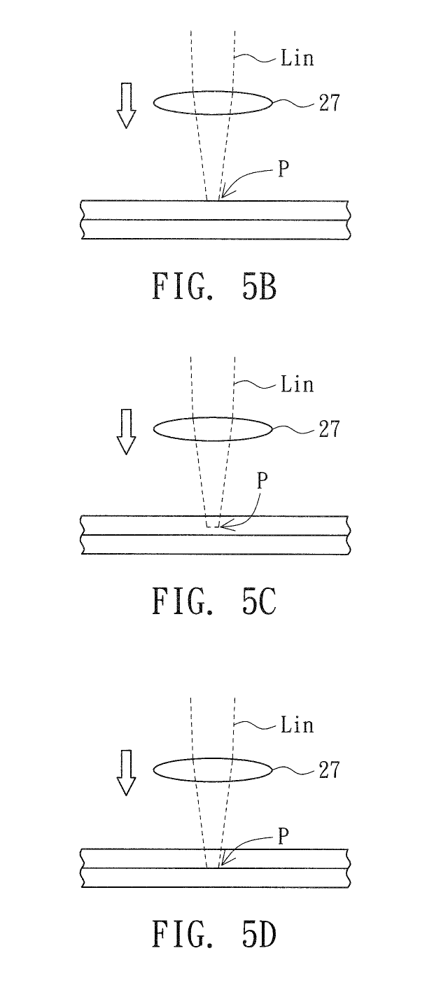

In the present embodiment of the invention, the transparent layer 10 is exemplified by a cover layer of an optical storage medium. The focusing element 27 is preferably moved with respect to the transparent layer 10 along the normal direction F1 at a fixed period. Meanwhile, the optical storage medium is rotated for detecting the thickness at different positions thereof. Afterwards, the relationship between the intensity of the FES S1 and the change in the shift of the focusing element 27 is recorded and charted into curves to show the change in the FES. Referrig to FIGS. 3A˜3C and FIG. 4. FIGS. 3A˜3C are diagrams illustrating the movement of the focal point passing through a first face. FIG. 4 is a diagram showing the intensity of the FES. When the focusing element 27 is moved along a direction A to make the focal point P pass through the first face 12, the FES S1 forms a first focus error curve Ce1 as indicated in FIG. 4. When the focal point P is focused on the first face 12 (as indicated in FIG. 3B) exactly, the intensity of the FES S1 outputted by the sensing element 23 corresponds to a first zero corssing point Q1 of the first focus error curve Ce1. Similarly, when the focusing element 27 continues to be moved along the direction A to make the focal point P pass through the second face 14, the FES S1 forms a second focus error curve Ce2. When the focal point P is focused on the second face 14 exactly, the intensity of the FES S1 outputted by the sensing element 23 corresponds to a second zero crossing point Q2 of the second focus error curve Ce2. The first and the second zero crossing points Q1 and Q2 substantially correspond to the layer sections of the stack structure. The processing element 25 obtains a first shift value and a second shift value of the focal point P according to the first zero crossing point Q1 of the first focus error curve Ce1 and the second zero crossing point Q2 of the second focus error curve Ce2. Then, the thickness of the transparent layer 10 is obtained according to the first shift value and the second shift value.

In the first embodiment of the invention disclosed above, the light emitting element 21 preferably is a laser diode. That is, the light beam Lᵢₙ is a laser beam, and diameter of the focal point P for measuring thickness is largely reduced from a convention dimension of 500 micrometer (μm) to approximately 1 μm or even less than 1 μm. Thus, the resolution of thickness measurement is effectively improved, and the error of thickness measurement is largely reduced. Furthermore, because the thickness of the transparent layer 10 is obtained by the processing element 25 from the FES S1 directly, the conventional FFT is omitted. Therefore, the calculating time for obtaining the thickness could be largely shortened and the efficiency of the measuring device 50 could be further improved. Moreover, the method for measuring thickness and measuring device 50 using the same disclosed in the present embodiment of the invention could determine the thickness of the material layer of an optical disc according to the FES S1 without adding any elements. The method for measuring thickness and measuring device 50 using the same disclosed in the present embodiment of the invention are compatible with conventional optical disc detecting system or optical disc driving system, and further saving the cost for developing new measuring devices.

### Second Embodiment

The method for measuring thickness and measuring device using the same according to the preferred embodiment of the invention can also be used to measure thickness of each transparent layer of an optical storage medium having more than two transparent layers. In the present embodiment of the invention, the optical storage medium is exemplified by having two transparent layers, and the disposition of the elements of the measuring device is similar to that of the measuring device 50 in the above-decribed first embodiment (as indicated in FIG. 2), and is not repeated here. The designations of the elements are similar to that of the first embodiment.

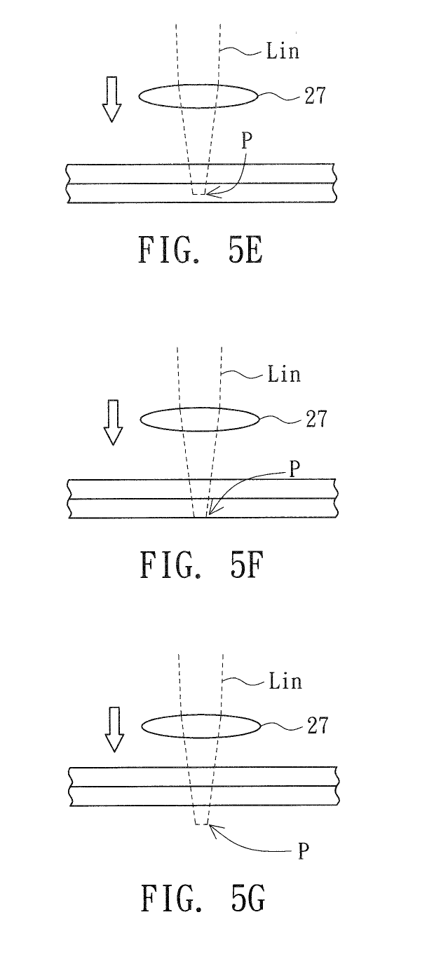

The measuring method of the present embodiment of the invention includes the following steps. First, a light beam is emitted to an optical storage medium. Next, an FES is generated according to a refracted beam of the light beam. The detailed description of these steps is similar to that of the first embodiment, and is not repeated here. Afterward, the focal point is moved along a normal direction of the optical storage medium. Referring to FIGS. 5A˜5G, diagrams illustrating the movement of the focal point passing through the first face, the second face and the third face of an optical storage medium are shown. The optical storage medium 60 includes a first transparent layer 61 and a second transparent layer 63, and has a first face 62, a second face 64, a third face 66 and a normal direction F2. The second face 64 is disposed between the first transparent layer 61 and the second transparent layer 63. The FES S1 converts into a first focus error curve, a second focus error curve and a third focus error curve respectively when the focal point P of the light beam Lᵢₙ moves and passes through the first face 62, the second face 64 and the third face 66. The processing element 25 obtains a first shift value and a second shift value of the focal point P according to a first level point of the first focus error curve and a second level point of the second focus error curve, and obtains the thickness of the first transparent layer 61 according to the first shift value and the second shift value. Moreover, the processing element 25 obtains a third shift value of the focal point P according to the second level point and a third level point of the third focus error curve, and obtains the thickness of the second transparent layer 63 according to the second shift value and the third shift value.

In the method for measuring thickness and measuring device using the same disclosed in the second embodiment of the invention, the FES S1 correspondignly converts into many focus error curves when the focal point passes through many faces, and the processing element 25 obtains the thickness of each transparent layers according to the focus error curves, such that the thickness of the optical storage medium having multiple layers can be measured promptly and accurately.

According to the method for measuring thickness and measuring device using the same disclosed in the above embodiments of the invention, a laser beam is emitted to the transparent layer of the optical storage medium for measuring thickness. The method for measuring thickness and measuring device using the same disclosed in the invention are not only increasing the resolution of measurement, but also improving the precision of measurement. Besides, as the FES is used for obtaining the thickness of the transparent layer, the conventional FFT can be omitted. Therefore, the measuring method is simplified and the efficiency of measurement is improved. Next, as the focal point is moved to pass through different faces, the thickness of each transparent layer is measured during each moving period of the focal point, and hence the detecting capability of the measuring device could be improved and the type of applicable optical storage medium are various. Furthermore, the method for measuring thickness and measuring device using the same are compatible with conventional optical disc detecting system or optical disc driving system, hence further saving the cost for developing new measuring devices.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for measuring thickness of a transparent layer having a first face, a second face and a normal direction, comprising:
emitting a light beam with a focal point to the transparent layer;
generating a focus error signal (FES) according to a refracted beam of the light beam;
moving the focal point along the normal direction to pass through the first face and the second face, the FES converts into a first focus error curve and a second focus error curve respectively when the focal point passes through the first face and the second face; and
obtaining the thickness of the transparent layer according to the first focus error curve and the second focus error curve.

2. The method according to claim 1, wherein the step of obtaining the thickness of the transparent layer comprises:
obtaining a first shift value of the focal point from the first focus error curve;
obtaining a second shift value of the focal point from the second focus error curve; and
calculating the thickness of the transparent layer according to the first shift value and the second shift value.

3. The method according to claim 1, wherein the light beam passes through a focusing element to form the focal point.

4. The method according to claim 3, wherein the step of moving the focal point is achieved by moving the focusing element.

5. The method according to claim 1, wherein the FES is generated by an optoelectronic detector.

6. The method according to claim 1, wherein the light beam reflected by the transparent layer is refracted into the refracted beam by an astigmatic lens.

7. The method according to claim 1, wherein the light beam is a laser beam.

8. The method according to claim 7, wherein diameter of the focal point is substantially smaller than or equal to 1 micrometer (μm).

9. A method for measuring thicknesses of a plurality of transparent layers of an optical storage medium having a first face, a second face, a third face and a normal direction, comprising:
emitting a light beam with a focal point to the optical storage medium;
generating an FES according to a refracted beam of the light beam;
moving the focal point along the normal direction to pass through the first-face, the second face and the third face, the FES converts into a first focus error curve, a second focus error curve and a third focus error curve respectively when the focal point passes through the first face, the second face and the third face; and
obtaining the thicknesses of the transparent layers according to the first focus error curve, the second focus error curve and the third focus error curve.

10. The method according to claim 9, wherein the first face, the second face and the third face are disposed sequentially, and the step of obtaining the thicknesses of the transparent layers comprises:
obtaining a first shift value of the focal point from the first focus error curve;
obtaining a second shift value of the focal point from the second focus error curve; and
calculating the thickness of a first transparent layer of the transparent layers according to the first shift value and the second shift value.

11. The method according to claim 10, wherein the step of obtaining the thicknesses of the transparent layers further comprises:
obtaining a third shift value of the focal point from the third focus error curve; and
calculating the thickness of a second transparent layer of the transparent layers according to the second shift value and the third shift value.

12. The method according to claim 9, wherein the light beam passes through a focusing element to form the focal point.

13. The method according to claim 12, wherein the step of moving the focal point is achieved by moving the focusing element.

14. The method according to claim 9, wherein the FES is generated by an optoelectronic detector.

15. The method according to claim 9, wherein the light beam reflected by the transparent layer is refracted into the refracted beam by an astigmatic lens.

16. The method according to claim 9, wherein the light beam is a laser beam.

17. The method according to claim 16, wherein diameter of the focal point is substantially smaller than or equal to 1 μm.

18. A measuring device for measuring thickness of a transparent layer having a first face, a second face and a normal direction, comprising:
a light emitting element for emitting a light beam to the transparent layer;
a sensing element for sensing a refracted beam of the light beam and generating an FES according to the refracted light beam; and
a processing element connected to the sensing element;
wherein, the FES converts into a first focus error curve and a second focus error curve respectively when a focal point of the light beam is moved along the normal direction and passes through the first face and the second face, and the processing element obtains the thickness of the transparent layer according to the first focus error curve and the second focus error curve.

19. The measuring device according to claim 18, wherein the processing element obtains a first shift value and a second shift value of the focal point according to the first focus error curve and the second focus error curve respectively, and calculates the thickness of the transparent layer according to the first shift value and the second shift value respectively.

20. The measuring device according to claim 18, further comprising:
a focusing element disposed between the light emitting element and the transparent layer for focusing the light beam to form the focal point.

21. The measuring device according to claim 20, wherein the focusing element is moved with respect to the transparent layer along the normal direction to move the focal point.

22. The measuring device according to claim 18, further comprising:
an astigmatic lens for refracting the light beam reflected by the transparent layer into the refracted beam.

23. The measuring device according to claim 18, wherein the sensing element is an optoelectronic detector.

24. The measuring device according to claim 18, wherein the light emitting element is a laser diode.
